(19) United States
(12) Patent Application Publication
(10) Pub. No.: US 2025/0106551 A1
(43) Pub. Date: Mar. 27, 2025

(54) ELECTRONIC KEYBOARD INSTRUMENT

(71) Applicant: CASIO COMPUTER CO., LTD., Tokyo (JP)

(72) Inventors: So SATO, Tokyo (JP); Hiroki AKAI, Tokyo (JP)

(21) Appl. No.: 18/894,608

(22) Filed: Sep. 24, 2024

(30) Foreign Application Priority Data
Sep. 25, 2023 (JP) 2023-159430

(51) Int. Cl. H04R 1/34; G10H 1/34; H04R 1/24

(52) U.S. Cl. CPC H04R 1/345; G10H 1/34; H04R 1/24; G10H 2220/221

(57) ABSTRACT

An electronic keyboard instrument includes a housing, a keyboard provided in connection with the housing and aligned in a left-right direction of the housing, a sound-emitting component provided inside the housing, and a reflector comprising a reflection surface configured to reflect sound from the sound-emitting component and provided at an upper portion of the housing inside the housing.

### CROSS-REFERENCE TO RELATED APPLICATION

This application is based upon and claims the benefit of priority under 35 USC 119 of Japanese Patent Application No. 2023-159430 filed on Sep. 25, 2023, the entire disclosure of which, including the specification, claims, drawings and abstract, is incorporated herein by reference in its entirety.

### BACKGROUND

### Technical Field

The present disclosure relates to an electronic keyboard instrument.

### Description of the Related Art

There have conventionally been known electronic keyboard instruments which can provide a key press feeling and a tone of musical sound which are like to those provided by a real piano. For example, Japanese Unexamined Patent Application Publication No. 2003-302974 (JP-A-2003-302974) discloses an electronic organ (an electronic keyboard instrument) including an organ main body, a keyboard, and a speaker accommodated in the organ main body and configured to produce an electronic sound as a key of the keyboard is pressed. In this electronic organ, a reflection plate is provided on a sound-emitting side of the speaker, so that a listener can capture a good play sound containing sound in a high-pitched sound range by reflecting sound emitted from a sound-emitting surface of the speaker by the reflection plate.

### SUMMARY

According to an aspect of the present disclosure, there is provided an electronic keyboard instrument including a housing, a keyboard provided in connection with the housing and aligned in a left-right direction of the housing, a sound-emitting component provided inside the housing, and a reflector provided at an upper portion of the housing inside the housing and comprising a reflection surface configured to reflect sound from the sound-emitting component.

### BRIEF DESCRIPTION OF THE DRAWINGS

FIG. 1 is a frontal overall perspective view of an electronic keyboard instrument according to an embodiment of the present disclosure;

FIG. 2 is a frontal perspective view of a main body of the electronic keyboard instrument according to the embodiment, which is partially transparent to show an internal configuration of the main body;

FIG. 3 is a bottom perspective view of the main body of the electronic keyboard instrument according to the embodiment, which shows a front top plate, a cover plate, a first perforated component, a second perforated component, and reflection plates;

FIG. 4 is a top view of the main body of the electronic keyboard instrument according to the embodiment with the front top plate, a back top plate, and the cover plate removed;

FIG. 5 is a sectional view of the main body part of the electronic keyboard instrument according to the embodiment, which is a sectional view taken along a line V-V in FIG. 4;

FIG. 6 is a left side view schematically showing the reflection plate at one end portion of the electronic keyboard instrument according to the embodiment and its vicinity; and

FIG. 7 is a top view of a part of the electronic keyboard instrument according to the embodiment, which is partially transparent to show the reflection plate at the one end portion and its vicinity.

### DESCRIPTION OF THE EMBODIMENT

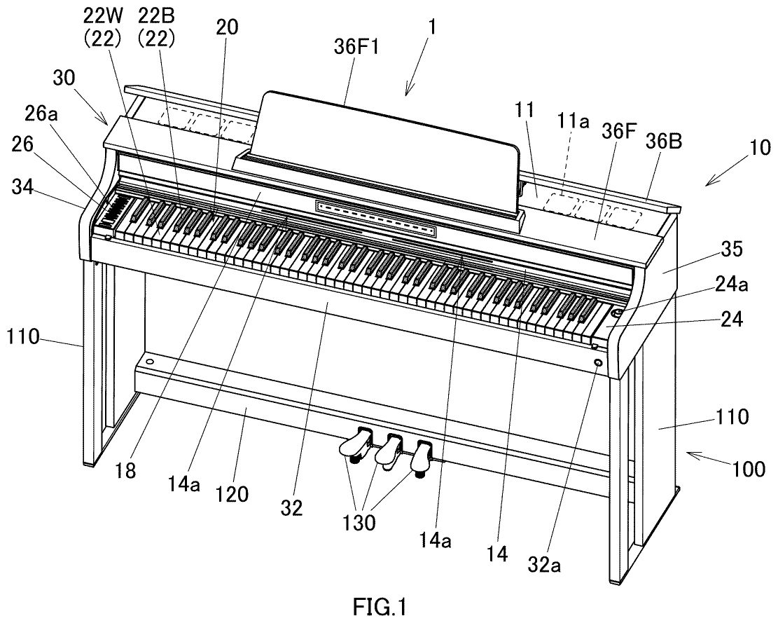

Referring to drawings, an embodiment of the present disclosure will be described. An electronic keyboard instrument 1 shown in FIG. 1 includes a main body 10 and a leg 100. As shown in FIG. 1, the main body 10 includes a keyboard 20 and a main body case (a housing) 30 which surrounds the keyboard 20 to hold it. The keyboard 20 has multiple keys 22 made up of white keys 22W and black keys 22B, which are exposed to an exterior of the keyboard 20 to be pressed by a player. The leg 100 includes a pair of side plates 110, a pedal frame 120, and a pedal device 130. In the following description, an alignment direction of the multiple keys 22 of the keyboard 20 is referred to as a left-right direction (in FIG. 1, a direction towards a left side is referred to as a leftward direction), an extending direction of each key 22 is referred to as a front-back direction (in FIG. 1, a direction towards a nearer side is referred to as a frontal direction), and an upper-lower direction of the electronic keyboard instrument 1 is referred to as an upper-lower direction (in FIG. 1, a direction towards an upper side is referred to as an upper direction).

As shown in FIG. 1, the pair of side plates 110 are plates which are erected on a setting surface on both left and right sides of the electronic keyboard instrument 1 in such a way that both plate surfaces of each plate are oriented in the left-right direction so as to support the main body case 30. The pedal frame 120 extends between the side plates 110 to connect them together at lower sides of the side plates 110. The pedal device 130 is provided at a substantially central portion of the pedal frame 120 in the left-right direction. In the electronic keyboard instrument 1, the main body case 30 of the main body 10 which is exposed to an exterior of the electronic keyboard instrument 1 and both the side plates 110 of the leg 100 are made of wood. Hereinafter, the configuration of the main body 10 will be described in detail.

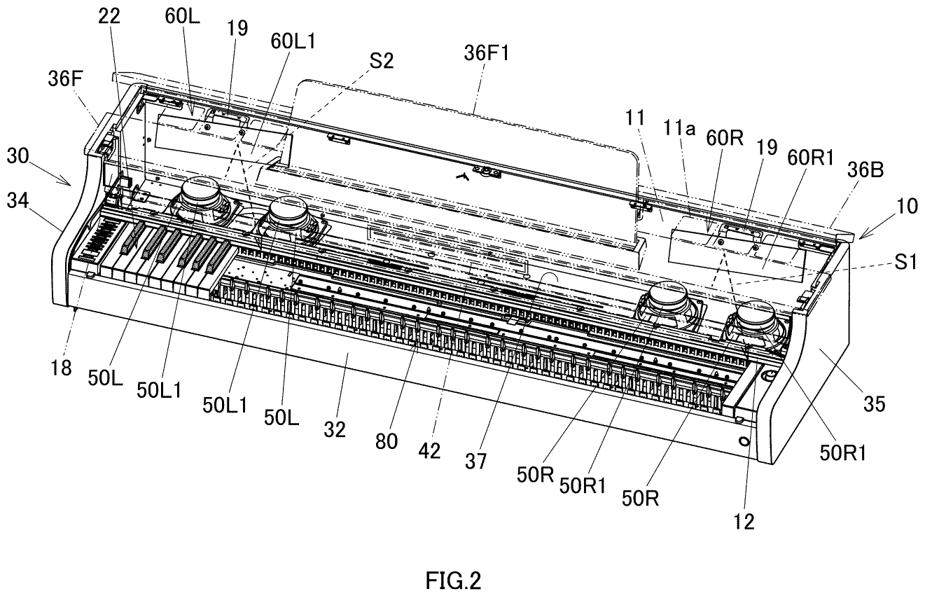

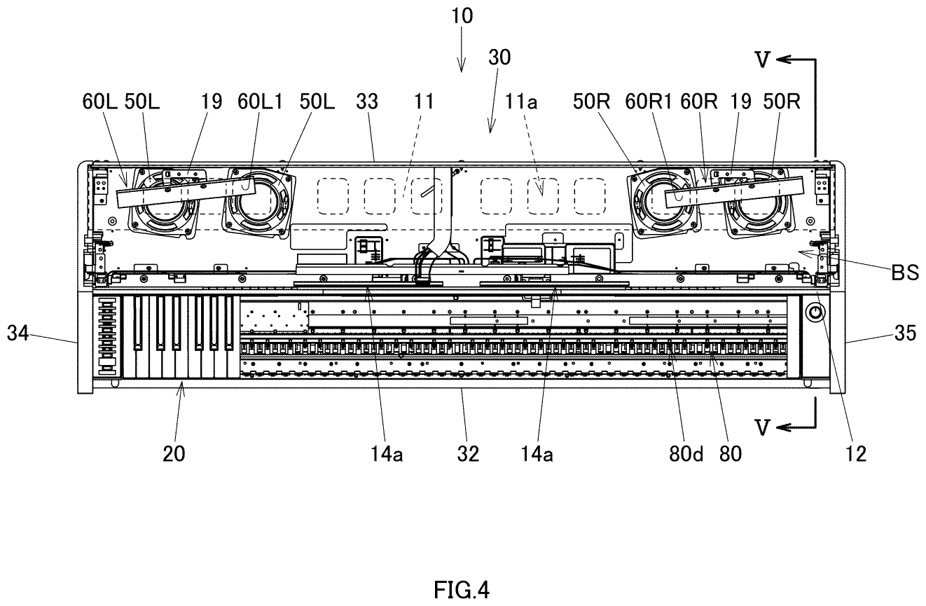

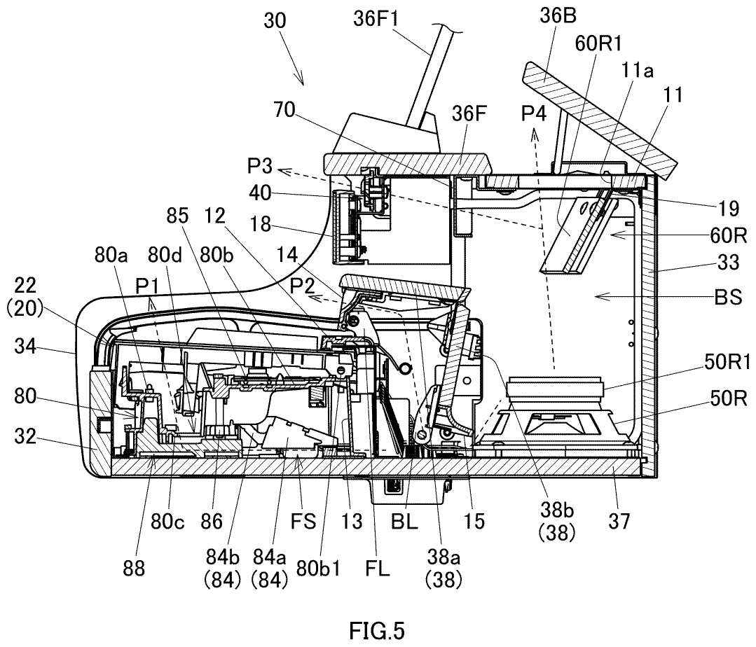

As shown in FIGS. 1 to 5, when viewed from an upper side and a lower side thereof, the main body case 30 has a substantially rectangular shape which is elongated laterally in such a way that a longitudinal direction thereof follows the left-right direction and includes thick plates including a front plate 32, a back plate 33, a left side plate 34, a right side plate 35, a front top plate 36F, a back top plate 36B, and a lower plate 37. In addition, the main body case 30 has a vertical section of a substantially L-shape (refer to FIG. 5). Here, in FIG. 2, the main body case 30 is shown being in a state in which the back plate 33 is removed, and in FIG. 4, the main body case 30 is shown being in a state in which the front top plate 36F, the back top plate 36B and a cover plate (an upper surface component) 11, which will be described later, are removed. The front plate 32 has a substantially rectangular shape which is elongated in the left-right direction and is provided to be positioned at a lower portion of a front end portion of the main body 10 and on a lower side of the keyboard 20, constituting a front surface of the main body case 30. A power button 32a is provided at a right end portion of the front plate 32 (refer to FIG. 1). The back plate 33 has a substantially rectangular shape which is elongated in the left-right direction and is provided on a back side of the main body 10, constituting a back surface of the main body case 30.

The left side plate 34 and the right side plate 35 each have a substantially rectangular shape which is elongated in the front-back direction. In each of the left side plate 34 and the right side plate 35, a step is provided at a substantially central portion in the front-back direction so that the height of a front half portion becomes substantially equal to the height of the keyboard 20. The left side plate 34 and the right side plate 35 are provided on a left side and a right side of the main body 10, respectively, to constitute a left side surface and a right side surface of the main body case 30, respectively. The front top plate 36F has a substantially rectangular shape which is elongated in the left-right direction and is provided on a front side of an upper backward portion of the main body 10 to constitute a part of an upper surface of the main body case 30. The back top plate 36B has a substantially rectangular shape which is elongated in the left-right direction and is provided on a back side of the upper backward portion of the main body 10 to constitute another part of the upper surface of the main body case 30. Here, as shown in FIGS. 1 and 4, a volume panel 24 on which a volume knob 24a and the like are disposed is provided between the keyboard 20 and the right side plate 35. In addition, a setting panel 26 on which various types of setting buttons 26a are disposed is provided between the keyboard 20 and the left side plate 34.

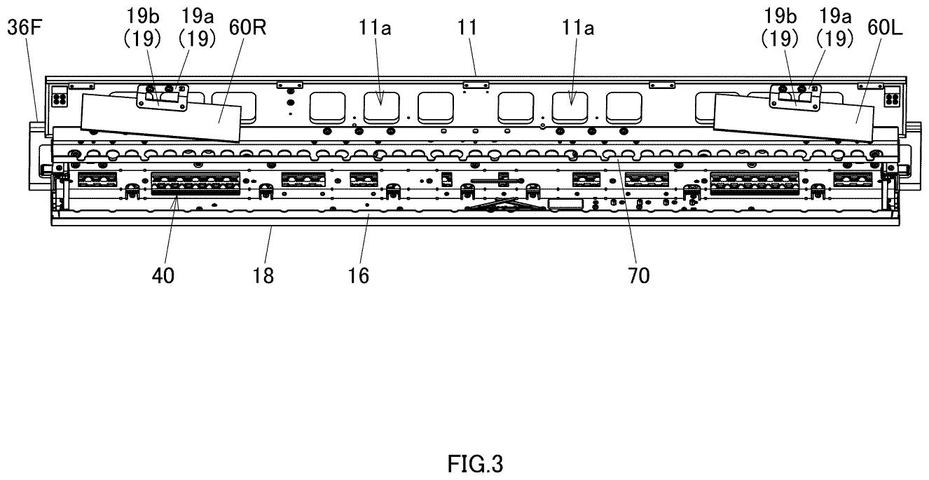

As shown in FIGS. 1, 2 and 5, the back top plate 36B is attached rotatably to the back plate 33 in such a way that the back plate 33 is opened from a front side thereof. The cover plate 11 has a substantially rectangular plate-like shape which is elongated in the left-right direction and is provided on a lower side of the back top plate 36B in such a way that both plate surfaces thereof are oriented in the upper-lower direction. Multiple upper openings (holes) 11a are provided in the cover plate 11 in such a way as to be disposed at predetermined intervals in the left-right direction (refer to FIGS. 1 and 3). These multiple upper openings (holes) each have a substantially rectangular shape and opens upwards from the inside the main body case 30. An upper surface and side surfaces of the cover plate 11 are covered with a saran net. With the back top plate 36B left open, an opening below the back top plate 36B is covered by the cover plate 11, so that an inside the main body case 30 is made invisible. In addition, a music stand 36F1 is attached to a substantially central portion of the front top plate 36F in the left-right direction. The lower plate 37 has a substantially rectangular shape which is elongated in the left-right direction and is provided on a lower side of the main body 10 to constitute a lower surface of the main body case 30.

As shown in FIGS. 2 and 4, a console component 12 has a substantially rectangular plate-like shape which is elongated in the left-right direction and is provided on back sides of the keys 22 of the keyboard 20 in such a way that both plate surfaces thereof are oriented in the upper-lower direction. The console component 12 is provided in a position where the console component 12 is overlapped vertically with a front end portion of the front top plate 36F in the upper-lower direction in such a manner as to cover back end portions of the keys 22 of the keyboard 20. The console component 12 prevents the inside of the main body case 30 from becoming visible via a gap at a back end portion of the keyboard 20 from an exterior of the electronic keyboard instrument 1. In addition, the keys 22 are restricted from moving in the front-back direction by providing the console component 12 on the back sides of the keys 22.

As shown in FIG. 5, multiple first metallic sheets 13 each have a substantially plate-like shape and extend downwards in such a way that both sheet surfaces thereof are oriented in the front-back direction. These multiple metallic sheets 13 are provided at a back end portion of a lower surface of the console component 12 in such a manner as to be disposed at predetermined intervals along the left-right direction. Lower end portions of the first metallic sheets 13 are attached to the lower plate 37. A back side of the keyboard 20 is fixed to the main body case 30 by the first metallic sheets 13. A space defined on front sides of the first metallic sheets 13 constitutes a space provided below the keyboard 20. Multiple notches, not shown, are provided individually in the lower end portions of the first metallic sheets 13. In the inside of the main body case 30, the space defined on the front sides of the first metallic sheets 13 and a space defined on back sides of the first metallic sheets 13 are made to communicate with each other via interspaces between the multiple first metallic sheets 13 and the notches provided in the first metallic sheets 13.

As shown in FIGS. 2 and 4, in the main body case 30, a section defined between the front plate 32 and the console component 12 is opened forwards and upwards, so that upper surfaces of the keys 22 of the keyboard 20 where the keys 22 are individually pressed and portions of front surfaces of the keys 22 are exposed to the outside from this opened section. The main body 10 includes a key cover 38 for covering the section of the keyboard 20 which is exposed to the outside. The key cover 38 is made up of a thick plate-like component and includes a front cover section 38a and a back cover section 38b, which are each made up of a plate-like component having a substantially rectangular shape which is elongated in the left-right direction. Then, the front cover section 38a and the back cover section 38b are aligned parallel in the front-back direction (refer to FIG. 5). The front cover section 38a is rotatably connected with a front link FL fixed to the main body case 30 via a front attachment 14, which is laterally elongated. Two attachment openings 14a are provided individually on a left side and a right side of a central portion (a handle section) of the front attachment 14 in the left-right direction in such a manner as to be opened to penetrate the front attachment 14. These attachment openings 14a each have a substantially rectangular shape which is elongated laterally.

As shown in FIG. 5, the back cover section 38b is rotatably connected with a back link BL fixed to the main body case 30 via a back attachment 15, which is laterally elongated. The front cover section 38a and the back cover section 38b are coupled together via a hinge in such a manner as to be folded into two sections and are accommodated in the space defined on the back sides of the first metallic sheets 13 in the inside of the main body case 30. Thus, the key cover 38 can freely be pulled into and out of the relevant space through a gap defined between the console component 12 and a display panel 18, which will be described later. In the electronic keyboard instrument 1, when the power supply is switched off, the key cover 38 is pulled out of the inside of the main body 10 to cover the opening, that is, the opened section of the main body case 30 where the keyboard 20 is exposed, whereby the exposed section of the keyboard 20 is designed to be covered.

In the electronic keyboard instrument 1, in such a state that the keyboard 20 is covered by the key cover 38, the gap defined between the console component 12 and the display panel 18 is covered by the back attachment 15. Additionally, in such a state that the key cover 38 is accommodated in the space defined on the back sides of the first metallic sheets 13 after the power supply is switched on, a slight gap is generated between the lower plate 37 and the back attachment 15. As a result of this, with the key cover 38 accommodated accordingly, the inside of the main body case 30 is defined into a front space FS defined on a front side of the key cover 38 and a back space BS defined on a back side of the key cover 38.

As shown in FIGS. 3 and 5, a second metallic sheet 16 extends in the left-right direction and is attached to a lower surface of the front top plate 36F. The display panel 18 is made up of a substantially rectangular thick plate component which is elongated in the left-right direction and is provided at a front end portion of the second metallic sheet 16 in such a way that a display surface is oriented in the frontal direction (refer to FIGS. 1 and 2). The display panel 18 is provided between the key cover 38 and the front top plate 36F while being disposed to define gaps on both upper and lower sides thereof. The gaps are opened towards the front side. Most of a gap defined between the key cover 38 and the front top plate 36F is covered by the display panel 18, whereby the back space BS is made invisible. In the display panel 18, the display surface is provided on a front surface thereof so that information on a play of the electronic keyboard instrument 1 is displayed on it.

As shown in FIGS. 3 and 5, a first perforated component 40 has a substantially rectangular plate-like shape which is elongated in the left-right direction and is attached with screws to a front side of the second metallic sheet 16 above the keyboard 20 in such a way that both component surfaces thereof are oriented in the front-back direction. The first perforated component 40 is provided on a front side or ahead of a reflection plate 60R(60L), which will be described later. Multiple holes are provided in the first perforated component 40. These multiple holes are opened from the inside towards the front side of the main body case 30 (in such a manner as to penetrate the first perforated component 40 in a thickness direction thereof). Additionally, the first perforated component 40 is provided on the second metallic sheet 16 on a back side of the display panel 18 and defines a slight gap between the display panel 18 and itself in the front-back direction. As shown in FIG. 5, a lower portion of the first perforated component 40 overlaps with the display panel 18 in the front-back direction.

As shown in FIGS. 2 and 4, the electronic keyboard instrument 1 includes two pairs, that is, four speakers (sound-emitting components) 50R, 50L in total, and the two pairs of speakers 50R, 50L are provided on a back side or a transversely deeper side of an upper surface of the lower plate 37 in the back space BS with each pair disposed at an end portion of the lower plate 37. These speakers 50R, 50L are provided downwards and backwards of the keyboard 20, and sound-emitting sections 50R1, 50L1, each having a shape of frustum of circular cone, of these speakers 50R, 50L are disposed above the lower plate 37. Sounds emitted from the sound-emitting sections 50R1, 50L1 are released into the back space BS. Of the two pairs of speakers 50R, 50L, the pair of speakers 50R disposed at one end portion or a first end portion of the lower plate 37 is provided on the upper surface of the lower plate 37 in a position lying closer to a right end portion thereof and functions to emit sounds in a high-pitched sound range (hereinafter, also referred to as a “right speaker pair (a high-pitched sound-emitting component pair) 50R”)). The pair of speakers 50L disposed at the other end portion or a second end portion of the lower plate 37 is provided on the upper surface of the lower plate 37 in a position lying closer to a left end portion thereof while being aligned parallel to the right speaker pair 50R in the left-right direction and functions to emit sounds in a low-pitched sound range (hereinafter, also referred to as a “left speaker pair (a low-pitched sound-emitting component pair 50L”)).

As shown in FIGS. 2 to 4, two reflection plates (reflectors) 60R, 60L are provided individually above the right and left speaker pairs 50R, 50L and directly below the cover plate 11 and are disposed at right and left end portions of the main body case 30 as component plates which are independent of the main body case 30. Then, the reflection plates 60R, 60L are configured to reflect sounds emitted from the right and left speaker pairs 50R, 50L, respectively. Specifically speaking, the reflection plate 60R (hereinafter, also referred to as a “right reflection plate (a high-pitched sound reflection plate) 60R”) is provided above the right speaker pair 50R in such a manner as to be overlapped in the upper-lower direction, while the reflection plate 60L (hereinafter, also referred to as a “left reflection plate (a low-pitched sound reflection plate) 60L”) is provided above the left speaker pair 50L in such a manner as to be overlapped in the upper-lower direction (refer to FIG. 4). The reflection plates 60R, 60L are attached with screws to a lower surface of the cover plate 11 via a third metallic sheet (an attachment) 19. The third metallic sheet 19 has a screwed section 19a where the third metallic sheet 19 is screwed to the cover plate 11 and an attachment section 19b extending downwards from a front edge of the screwed section 19a for attachment of the reflection plates 60R, 60L (refer to FIG. 3).

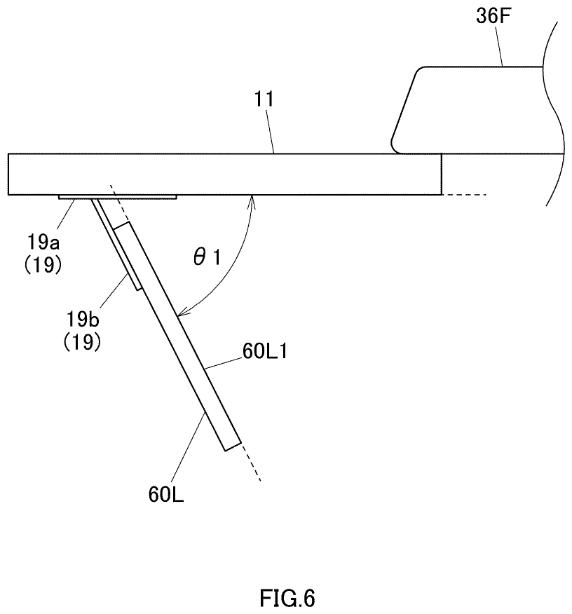

The reflection plates 60R, 60L are formed of the same material and are each made up of a wood piece having a substantially rectangular shape which is elongated laterally. Additionally, the reflection plates 60R, 60L are provided at a height substantially equal to that of the display panel 18 in the inside of the main body case 30. As a result, sounds reflected by the reflection plates 60R, 60L are guided effectively towards the first perforated component 40 and the upper openings 11a. In the reflection plates 60R, 60L, surfaces directed to the front side are made into reflection surfaces 60R1, 60L1 each configured to reflect sound. The reflection plates 60R, 60L are provided in such a way that the reflection surfaces 60R1, 60L1 are inclined slightly upwards towards the first perforated component 40 and the upper openings 11a (refer to FIG. 5). Reflection angles of the reflection surfaces 60R1, 60L1 of the reflection plates 60R, 60L are set equally. Specifically speaking, as shown in FIG. 6, the reflection plates 60R, 60L are provided in such a manner as to be inclined slightly upwards so that an angle θ1 formed by the cover plate 11 and the reflection surface 60L1, in other words, an angle θ1 formed by the reflection surfaces 60R1, 60L1 with respect to the front-back direction falls within a range of 60 degrees to 70 degrees.

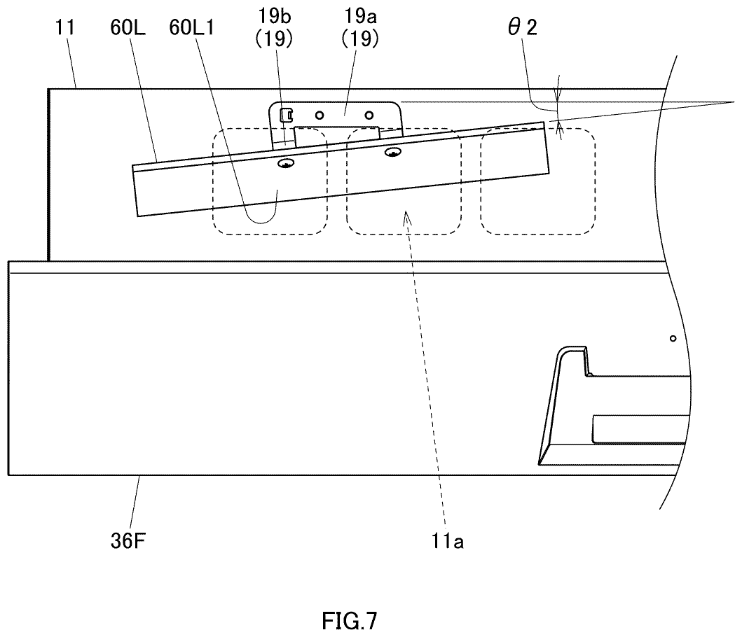

In addition, each reflection plates 60R and 60L is provided with its reflection surface 60a positioned in a slightly inclined posture towards the right side in the left-right direction. Specifically, each reflection plates 60R and 60L is set up so that its reflection surfaces 60R1 and 60L1 are inclined towards the right speaker pair 50R from the left speaker pair 50L. As a result, the reflection surface 60L1 of the left reflection plate 60L is directed towards the player (towards the front side and a central portion in the left-right direction of the main body case 30), whereas the reflection surface 60R1 of the right reflection plate 60R is directed in a direction in which the reflection surface 60R1 moves away from the player (towards the front side and the outside in the left-right direction of the main body case 30) (refer to FIG. 4). Specifically speaking, as shown in FIG. 7, the reflection plates 60R, 60L are provided in such a manner as to be slightly inclined posture towards the right side so that an angle θ2 formed by the back plate 33 and an upper side of the reflection plate 60, in other words, an angle θ2 formed by the reflection surfaces 60R1, 60L1 relative to the left-right direction falls within a range of 5 degrees to 10 degrees. Here, the attachment section 19b of the third metallic sheet 19 is provided to extend parallel to the corresponding reflection surface of the respective reflection surfaces 60R1, 60L1 of the reflection plates 60R, 60L (refer to FIG. 6).

Here, the propagation of sounds emitted from the speakers 50R, 50L and reflected by the reflection plates 0R, 60L will be described. As shown in FIG. 4, sounds emitted from the speakers 50R, 50L are divided into a direct sound which travels while being reflected in the inside of the main body case 30 to eventually reach directly the player (the front side and the central portion in the left-right direction of the main body case 30) from the inside of the main body case 30 and an indirect sound which spreads from the inside of the main body case 30 to the outside of the main body case 30 without travelling in the inside of the main body case 30 towards the player to eventually reach the player while being reflected on an external wall or the like. A part of the sound traveling while being reflected in the inside of the main body case 30 is reflected by the reflection plates 60R, 60L to eventually travel to the outside of the main body case 30.

In those sounds, sounds emitted from the right speaker pair 50R are made up of a sound in a high-pitched sound range, and hence, the sounds are highly directive and are difficult to spread. Thus, in the event that the right reflection plate 60R is not provided, there will be more direct sound components than indirect sound components. In contrast with this, with the present embodiment, since the reflection surface 60R1 of the right reflection plate 60R is slightly inclined towards the right side (in the direction in which the reflection surface 60R1 moves away from the player), sounds emitted from the right speaker pair 50R and reflected by the reflection surface 60R1 (hereinafter, referred to as an “outward reflection sound S1” (refer to FIG. 2)) tend to be easily directed towards the outside of the main body case 30. As a result, when compared with the configuration in which the right reflection plate 60R is not provided, of the sounds emitted from the right speaker pair 50R, indirect sound components are increased, whereas direct sound components are suppressed. As a result, the sounds emitted from the right speaker pair 50R are improved in such a manner that the direct sound components and the indirect sound components are balanced substantially uniform.

On the other hand, sounds emitted from the left speaker pair 50L are made up of a sound in a low-pitched sound range, and hence, the sounds are less directive and are easy to spread. Thus, in the event that the left reflection plate 60L is not provided, direct sound components will be insufficient compared with indirect sound components. In contrast with this, with the present embodiment, since the reflection surface 60L1 of the left reflection plate 60L is slightly inclined towards the right side (towards the player) as with the right reflection plate 60R, sounds emitted from the left speaker pair 50L and reflected by the reflection surface 60L1 (hereinafter, referred to as an “inward reflection sound S2” (refer to FIG. 2)) tend to be easily directed towards the player. As a result, when compared with the configuration in which the left reflection plate 60L is not provided, of the sounds emitted from the left speaker pair 50L, direct sound components are increased, whereas indirect sound components are suppressed. As a result, the sounds emitted from the left speaker pair 50L are also improved in such a manner that the direct sound components and the indirect sound components are balanced substantially uniform.

When the electronic keyboard instrument 1 of the present embodiment is in a real use, the head of the player is positioned higher than the reflection plates 60R, 60L. In the present embodiment, however, since the reflection surfaces 60R1, 60L1 of the reflection plates 60R, 60L are provided in such a manner as to be inclined slightly upwards, when compared with a case in which the reflection surfaces 60R1, 60L1 are directed directly to the front side, sounds emitted from the speakers 50R, 50L and reflected by the reflection plates 60R, 60L are made to easily reach the ears of the player. Thus, according to the present embodiment described heretofore, as a result of the provision of the reflection plates 60R, 60L, in sounds of the high-pitched sound range emitted from the right speaker pair 50R and sounds of the low-pitched sound range emitted from the left speaker pair 50L, direct sounds and indirect sounds are made to reach the ears of the player in a good balance.

In addition, in the event that the reflection plates 60R, 60L (the respective reflection surfaces 60R1, 60L1) are not attached to the lower surface of the cover plate 11 but support legs are provided in such a manner as to be connected to back surfaces or the like of the reflection plates 60R, 60L and erected perpendicularly from the lower plate 37 to fix (support) the reflection plates 60R, 60L at the height shown in FIG. 5, disposing the right and left speaker pairs 50R, 50L at the right and left end portions (of the lower plate 37) in the inside of the main body case 30, respectively, makes it difficult to provide the support legs and the reflection plates 60R, 60L at the right and left end portions accordingly. Additionally, in the event that the right and left speaker pairs 50R, 50L are disposed, respectively, at the right and left end portions (of the lower plate 37) in the inside of the main body case 30 and further, the reflection plates 60R, 60L are attached to the lower surface of the cover plate 11 while being disposed closer to the central portion in the left-right direction in the inside of the main body case 30, sounds emitted from the right and left speaker pairs 50R, 50L are made difficult to be reflected on the corresponding reflection plates 60R, 60L, whereby it becomes difficult to separate sounds desired to be directed towards the player from sounds not desired to be directed towards the player. In other words, sounds from the right and left speaker pairs 50R, 50L are made difficult to reach the corresponding reflection surfaces 60R1, 60L1 even though the angles of the reflection plates 60R, 60L are controlled. In contrast with this, with the electronic keyboard instrument 1 according to the present embodiment, the right and left speaker pairs 50R, 50L and the corresponding reflection plates 60R, 60L are provided at the right and left end portions in the inside of the main body case 30 in the disposing manner described above in the inside of the main body case 30, sounds in the high-pitched sound range emitted from the right speaker pair 50R and sounds in the low-pitched sound range emitted from the left speaker pair 50L can be made to be reflected effectively by the corresponding reflection plates 60R, 60L, respectively.

Although it is difficult to reduce a widthwise dimension (a dimension in the left-right direction) of the keyboard 20 and the number of keys 22 in the keyboard 20, a dimension in the front-back direction of the keyboard 20 is still desired to be reduced as much as possible. In this case, the desired reduction can be dealt with by reducing the thickness of the back plate 33. However, when the third metallic sheet 19 is fixed to the back plate 33 so thinned, screws with which the third metallic sheet 19 is fixed tend to be exposed easily to the exterior of the main body case 30, resulting in a risk of damaging the external appearance of the electronic keyboard instrument 1. Then, according to the present embodiment, the thickness direction of the third metallic sheet 19 follows the upper-lower direction which is different from the front-back direction, and the third metallic sheet 19 is fixed to the cover plate 11 which is covered by the back top plate 36B, so that the cover plate 11 is hardly exposed to the exterior of the main body case 30, whereby the external appearance of the electronic keyboard instrument 1 is restrained from being damaged.

Returning to the description of configurations of other constituent components provided in the inside of the main body case 30, as shown in FIGS. 3 and 5, a second perforated component 70 is provided behind the first perforated component 40 and above the keyboard 20 and is attached with screws to a front end portion of the lower surface of the cover plate 11 in such a way that both component surfaces are oriented in the front-back direction. Then, this second perforated component 70 has a substantially rectangular plate-like shape which is elongated in the left-right direction. Multiple holes are provided in the second perforated component 70 in such a manner as to be opened from the inside towards the front side of the main body case 30 (that is, in such a manner as to penetrate the second perforated component 70 in a thickness direction thereof). The second perforated component 70 is provided ahead of the reflection plates 60R, 60L in such a manner that a space is defined in the front-back direction between the reflection plates 60R, 60L and the second perforated component 70. Of the sounds reflected on the respective reflection surfaces 60R1, 60L1 of the reflection plates 60R, 60L, the sounds traveling forwards from the reflection surfaces 60R1, 60L1 are allowed to pass through the holes provided in the second perforated component 70 to be released towards the front side.

Subsequently, configurations of other constituent components provided in the front space FS will be described. As shown in FIG. 5, a first support 80 is provided on the front sides of the first metallic sheets 13 in the front space FS. first The support 80 is provided over substantially a whole area of the lower side of the keyboard 20 and is laterally elongated as with the keyboard 20 (refer to FIG. 2). The first support 80 is a hollow component which is opened downwards. The keyboard 20 is supported on the main body case 30 by the first support 80 and a second support 88, which will be described later. The second metallic sheet 16 described above is provided on a back side of the first support 80.

A front end portion of the first support 80 is made into a convex section 80a which protrudes upwards into a convex shape. A portion of the first support 80 which is positioned on lower sides of the black keys 22B of the keys 22 is made into a platform section 80b which protrudes upwards into a platform-like shape. A portion of the first support 80 lying between the convex section 80a and the platform section 80b is made into a concave section 80c which is recessed downwards into a concave shape. A rotatable fulcrum portion 80b1 is provided at a back portion of an upper surface of the platform section 80b so as to support rotatably back end portions of the keys 22 of the keyboard 20. Additionally, a control substrate 85 is provided on the upper surface of the platform section 80b. Switches are provided on the control substrate 85 so as to produce sounds corresponding to the keys 22 which are pressed. Multiple concave section openings 80d are opened in the front-back direction and the upper-lower direction in the concave section 80c and are disposed in such a manner as to be aligned side by side in the left-right direction (refer to FIG. 4).

Multiple hammers 84 are provided in a part of a space defined inside the first support 80 which lies below the platform section 80b and are connected with the corresponding keys 22. Each of the hammers 84 includes a substantially triangular weight section 84a and an arm section 84b which extends in a straight line to the front side from the weight section 84a. The arm section 84b is rotatably supported on a pivot 86 provided in a front portion of the space defined in the inside of the platform section 80b. When one of the keys 22 is pressed, the weight section 84a of the corresponding hammer 84 is raised, whereby a feeling of heaviness can be felt by the player when he or she presses the key 22. This can help the player obtain a key press feeling similar to that of a real piano.

The second support 88 is disposed on the lower plate 37 and is provided in a portion of the space defined in the inside of the first support 80 which lies further forwards than the portion where the hammers 84 are disposed. The second support 88 is a hollow component which is opened downwards and is attached to the main body case 30 by being screwed down to the lower plate 37. The keyboard 20 is indirectly supported on the main body case 30 made of wood via the first support 80 by the second support 88. The pivot 86 is provided on the second support 88 to support the arm section 84b of the hammer 84.

Subsequently, communication paths P1 to P4 will be described. The communication paths P1 to P4 are provided in the inside of the main body case 30 and constitute sound release paths for sounds emitted from the speakers 50R, 50L. As shown in FIG. 5, in the electronic keyboard instrument 1 according to the present embodiment, four communication paths P1 to P4 are provided in the inside of the main body case 30 as sound release paths along which sounds emitted from the four speakers 50R, 50L are released to eventually reach the outside of the main body case 30. A first communication path P1, which is a first communication path, constitutes a communication path which extends from the four speakers 50R, 50L to reach the front space FS by way of a gap defined between the lower plate 37 and the back attachment 15, passes underneath the hammers 84 to extend further from the concave section openings 80d to an upper side of the first support 80, and passes through interspaces defined between the keys 22 to eventually reach the outside of the main body case 30.

A second communication path P2, which is a second communication path, constitutes a communication path which extends from the four speakers 50R, 50L to reach the back sides of the first metallic sheets 13 by way of the gap defined between the lower plate 37 and the back attachment 15, passes around the back sides of the first metallic sheets 13 to extend upwards, and extends further from the attachment openings 14a to eventually reach the outside of the main body case 30. A third communication path P3, which is a third communication path, constitutes a communication path which extends upwards from the four speakers 50R, 50L through the back space BS, passes sequentially through the holes provided in the second perforated component 70 and the holes provided in the first perforated component 40, and extends further from the gap defined between the display panel 18 and the front top plate 36F to eventually reach the outside of the main body case 30. A fourth communication path P4, which is a fourth communication path, constitutes a communication path which extends upwards from the four speakers 50R, 50L through the back space BS to eventually reach the outside of the main body case 30 by way of the upper openings 11a in the cover plate 11.

Here, most of the sounds emitted from the four speakers 50R, 50L and reflected by the reflection plates 60R, 60L reach the outside of the main body case 30 by way of the fourth communication path P4, and the other sound components reach the outside of the main body case 30 by way of the third communication path P3. In the present embodiment, the sounds emitted from the four speakers 50R, 50L and travelling by way of the third communication path P3 and the fourth communication path P4 are reflected by the reflection plates 60R, 60L, whereby as has been described before, both sounds in the high-pitched sound range and sounds in the low-pitched sound range are improved in such a manner that the direct sound components and the indirect sound components are balanced substantially uniform to thereby be propagated to the player in a good balance. Here, since sounds reflected by the reflection plates 60R, 60L need only pass through at least the third communication path P3 to eventually reach the outside of the main body case 30, the configuration of the reflection plates 60R, 60L is not limited to the one in which the reflection plates 60R, 60L are inclined upwards, and hence, the reflection plates 60R, 60L may be configured to be inclined downwards.

Hereinafter, the electronic keyboard instrument 1 according to the present embodiment will be described while being compared with the related art described before. There is a case in which sound emitted from a speaker is desired to be discharged from an inside of a housing of an electronic keyboard instrument towards the head of a player so that the player can obtain a good sound image. With the electronic organ disclosed in JP-A-2003-302974 described above, however, the speaker is mounted in such a state that the sound-emitting surface is directed downwards, whereby sound emitted from the speaker is discharged outwards from below the organ main body so as to be directed towards the reflection plate. Due to this configuration, the sound emitted from the speaker and reflected by the reflection plate cannot be sent towards the player effectively, thereby making it difficult to reproduce a sound field similar to that of a real piano.

On the other hand, the electronic keyboard instrument 1 according to the present embodiment has the main body case 30, the keyboard 20 provided in the main body case 30 and aligned in the left-right direction of the main body case 30, the speakers 50R, 50L provided inside the main body case 30, and the reflection plates 60R, 60L having the reflection surfaces 60R1, 60L1 configured to reflect sounds from the speakers 50R, 50L and provided at the upper portion of the main body case 30 inside the main body case 30.

According to the electronic keyboard instrument 1 of the present embodiment, which has the configuration described above, by adjusting the angles of the reflection plates 60R, 60L, it is possible to reflect the sounds in the low-pitched sound range which are less directive in sounds emitted from the speakers 50R, 50L on the reflection plates 60R, 60L. This increases the direct sound components for the inward reflection sound S2 which is directed from the inside of the main body case 30 towards the player. In addition, by adjusting the angles of the reflection plates 60R, 60L, it is possible to reflect the sounds in the high-pitched sound range which are highly directive in the sounds emitted from the speakers 50R, 50L on the reflection plates 60R, 60L. This increases the indirect reflection sound for the outward reflection sound S1 which is directed from the inside of the main body case 30 towards the outside of the main body case 30. As a result, with the electronic keyboard instrument 1, the sounds emitted from the speakers 50R, 50L are improved in such a manner that the direct sound components and the indirect sound components are balanced substantially uniform, thereby making it possible to reproduce a sound field similar to that of a real piano.

In addition, the electronic keyboard instrument 1 according to the present embodiment includes the cover plate 11 provided at the upper portion of the main body case 30, and the reflection plates 60R, 60L are provided on the cover plate 11 inside the main body case 30. In other words, the reflection plates 60R and 60L are fixed to the lower part of the cover plate 11. With this configuration, the specific configuration can be provided for the attachment positions of the reflection plates 60R, 60L in the inside of the main body case 30. Additionally, in the electronic keyboard instrument, the position of the head of the player lies above the main body case 30, and hence, as a result of the reflection plates 60R, 60L being provided at the upper portion of the main body case 30, sounds emitted from the speakers 50R, 50L and reflected on the reflection plates 60R, 60L are allowed to reach the player effectively.

With the electronic keyboard instrument 1 according to the present embodiment, the cover plate 11 has the holes 11a that opens upwards from the inside of the main body case 30. As a result, most of sounds emitted from the speakers 50R, 50L and reflected on the reflection plates 60R, 60L pass through the holes 11a provided in the cover plate 11 to travel towards the outside of the main body case 30, whereby the sounds emitted from the speakers 50R, 50L and reflected on the reflection plates 60R, 60L are allowed to reach the player effectively.

With the electronic keyboard instrument 1 according to the present embodiment, the reflection plates 60R, 60L include the left reflection plate 60L provided above the left speaker pair 50L and the right reflection plate 60R provided above the right speaker pair 50R, respectively. With this configuration, a part of sounds emitted from the left speaker pair 50L is reflected by the left reflection plate 60L and a part of sounds emitted from the right speaker pair 50R is reflected by the right reflection plate 60R. As a result, sounds emitted from the left speaker pair 50L and sounds emitted from the right speaker pair 50R can be reflected by the different reflection plates 60R, 60L.

With the electronic keyboard instrument 1 according to the present embodiment, the reflection plates 60R and 60L are arranged such that the reflection surfaces 60R1, 60L1 are inclined upward and toward the right speaker pair 50R from the left speaker pair 50L in the left-right direction. With this configuration, the inward reflection sound S2 which is emitted from the left speaker pair 50L and reflected by the left reflection plate 60L is allowed to be directed towards the player (towards the central portion in the left-right direction of the main body case 30 and the upper side of the main body case 30) effectively. In addition, the outward reflection sound S1 which is emitted from the right speaker pair 50R and reflected by the right reflection plate 60R is also allowed to be directed towards the outside of the main body case 30 (in the direction in which the outward reflection sound S1 moves away from the player) effectively.

With the electronic keyboard instrument 1 according to the present embodiment, the reflection plates 60R, 60L are provided such that the reflection surfaces 60R1, 60L1 are inclined at an angle θ1 within the range of 60 degrees to 70 degrees relative to the front-back direction of the main body case 30 respectively, towards the upper side of the main body case 30. As a result, the reflection surface 60L1 can be provided with the specific angle at which sounds emitted from the left speaker pair 50L are reflected effectively towards the player by the left reflection plate 60L.

In addition, with the electronic keyboard instrument 1 according to the present embodiment, the reflection plates 60R, 60L are provided respectively such that the reflection surfaces 60R1, 60L1 are inclined at an angle θ2 within the range of 5 degrees to 10 degrees relative to the left-right direction of the main body case 30, towards the right speaker pair 50R from the left speaker pair 50L in the left-right direction. As a result, the reflection surface 60R1 can be provided with the specific angle at which sounds emitted from the right speaker pair 50R are reflected effectively towards the outside of the main body case 30 by the right reflection plate 60R.

With the electronic keyboard instrument 1 according to the present embodiment, the left speaker pair 50L is provided at the left end portion in the left-right direction inside the main body case 30, and the right speaker pair 50R is provided at the right end portion in the left-right direction inside the main body case 30. With this configuration, as in the case with a concert grand piano or the like, sounds in the high-pitched sound range are emitted from the right end portion of the main body case 30, and sounds in the low-pitched sound range are emitted from the left end portion of the main body case 30. Then, the sounds so emitted can be improved in such a manner that direct sound components and indirect sound components are balanced substantially uniform, thereby making it possible to reproduce a sound field similar to that of a concert grand piano.

In addition, with the electronic keyboard instrument 1 according to the present embodiment, the left reflection plate 60L provided above the left speaker pair 50L and the right reflection plate 60R provided above the right speaker pair 50R are provided with the same inclination angles relative to the main body case 30. With this configuration, the left reflection plate 60L and the right reflection plate 60R can be made common to each other, and hence, the manufacturing process and cost of the electronic keyboard instrument 1 can be simplified and reduced.

With the electronic keyboard instrument 1 according to the present embodiment, there are provided the first perforated component 40 and the second perforated component 70 both of which include the holes that open from the inside of the main body case 30 towards the front side and provided further forwards of the main body case 30 than the reflection plates 60R, 60L and further upwards than the keyboard 20. With this configuration, sounds emitted from the speakers 50R, 50L and reflected to the front side by the corresponding reflection plates 60R, 60L pass through the first perforated component 40 and the second perforated component 70 to be directed towards the player, whereby the first perforated component 40 and the second perforated component 70 constitute the sound propagation path, thereby making it possible to direct the sounds towards the player effectively.

Here, the embodiment of the present disclosure that has been described heretofore is presented as the example, and hence, there is no intention to limit the scope of the present disclosure by the embodiment. The novel embodiment can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic keyboard instrument comprising:
a housing;
a keyboard provided in connection with the housing and aligned in a left-right direction of the housing;
a sound-emitting component provided inside the housing; and
a reflector provided at an upper portion of the housing inside the housing and comprising a reflection surface configured to reflect sound from the sound-emitting component.

2. The electronic keyboard instrument according to claim 1, further comprising:
an upper surface component provided at an upper portion of the housing,
wherein the reflector is fixed to a lower portion of the upper surface component inside the housing.

3. The electronic keyboard instrument according to claim 2,
wherein the reflector is attached to the upper surface component via an attachment.

4. The electronic keyboard instrument according to claim 2,
wherein the upper surface component comprises a hole that opens upwards from an inside of the housing.

5. The electronic keyboard instrument according to claim 4,
wherein the reflector is provided such that the reflection surface is inclined to face an upper side of the housing.

6. The electronic keyboard instrument according to claim 5,
wherein the reflector is provided such that the reflection surface is inclined at an angle within a range of 60 degrees to 70 degrees relative to a front-back direction of the housing, towards an upper side of the housing.

7. The electronic keyboard instrument according to claim 1,
wherein the sound-emitting component comprises a low-pitched sound-emitting component provided at a first end portion in the left-right direction and configured to emit sound in a low-pitched sound range and a high-pitched sound-emitting component provided at a second end portion in the left-right direction and configured to emit sound in a high-pitched sound range.

8. The electronic keyboard instrument according to claim 7,
wherein the reflector comprises a first reflector provided above the low-pitched sound-emitting component and a second reflector provided above the high-pitched sound-emitting component.

9. The electronic keyboard instrument according to claim 8,
wherein the first reflector and the second reflector are respectively provided such that their reflective surfaces are inclined towards the high-pitched sound-emitting component from the low-pitched sound-emitting component in the left-right direction.

10. The electronic keyboard instrument according to claim 9,
wherein the first reflector and the second reflector are respectively provided such that their reflective surfaces are inclined at an angle within a range of 5° to 10° relative to the left-right direction of the housing, towards the high-pitched sound emitting component from the low-pitched sound emitting component in the left-right direction.

11. The electronic keyboard instrument according to claim 7,
wherein the low-pitched sound-emitting component is provided at a left end portion in the left-right direction inside the housing, and
wherein the high-pitched sound-emitting component is provided at a right end portion in the left-right direction inside the housing.

12. The electronic keyboard instrument according to claim 8,
wherein the first reflector and the second reflector are provided with a same inclination angle relative to the housing.

13. The electronic keyboard instrument according to claim 1, further comprising:
a perforated component comprising a hole that opens from an inside of the housing towards a front side and provided further forwards of the housing than the reflector and further upwards than the keyboard.
